(19) United States
(12) Patent Application Publication
(10) Pub. No.: US 2015/0334121 A1
(43) Pub. Date: Nov. 19, 2015

(54) SYSTEM AND METHOD FOR COLLECTING AND STREAMING BUSINESS REVIEWS

(71) Applicant: Marius Hernberg, Aventura, FL (US)

(72) Inventor: Marius Hernberg, Aventura, FL (US)

(21) Appl. No.: 14/656,306

(22) Filed: Mar. 12, 2015

Related U.S. Application Data
(63) Continuation-in-part of application No. 14/276,653, filed on May 13, 2014, now abandoned.

(51) Int. Cl. H04L 29/06; G06Q 30/02

(52) U.S. Cl. CPC H04L 63/126; G06Q 30/0282; H04L 63/0428; H04L 63/061; H04L 63/0861

(57) ABSTRACT

The present invention generally relates to the collection and distribution of business reviews. Specifically, this invention relates to a system and method for collecting business reviews in a manner that improves the granularity of information that can be collected, allows for the needs of various different third-party review providers to be met, and prevents tampering and falsification of business reviews. Reviews with various levels of verification or validation are kept in a central database that can be accessed by multiple external business review providers. Review providers can choose which level of validation they find acceptable and use only reviews from the database that meet their requirements.

### RELATED APPLICATIONS

This application is a continuation-in-part of and claims priority to U.S. patent application Ser. No. 14/276,653, entitled “System and Method for Collecting and Streaming Business Reviews” filed May 13, 2014, the contents of which is herein incorporated by reference in its entirety.

### FIELD OF THE INVENTION

The present invention generally relates to the collection and distribution of business reviews. Specifically, this invention relates to a system and method for collecting business reviews in a manner that improves the granularity of information that can be collected, allows for the needs of various different third-party review providers to be met, and prevents tampering and falsification of business reviews. Reviews with various levels of verification or validation are kept in a central database that can be accessed by multiple external business review providers. Review providers can choose which level of validation they find acceptable and use only reviews from the database that meet their requirements.

### BACKGROUND OF THE INVENTION

One of the most important aspects of any business is the feedback and reviews that business receives from its customers. There are a number of common ways through which businesses collect such feedback and reviews, including paper, phone, and online surveys, as well as online review websites. Surveys are important to a business because they are used to help a business learn how to improve to better meet the demands of the customer so that those customers can be retained. Similarly, reviews are vital to providing a positive reputation for a business, which is key factor in attracting new customers.

Current systems and methods for collecting customer reviews are inefficient and unorganized. A common example of how reviews are collected is through online review websites. Online review websites, however, can be disjointed and unreliable because there is no central database that can be used to populate each separate review website. This is ineffective from the perspective of a business because the reviews that business receives are scattered over a number of different review websites that might not ever be seen by an individual looking for reviews about that business. Finally, the current methods for collecting reviews and customer feedback are sporadic because a business must often rely on that customer or client taking the survey or submitting a review after that customer or client leaves the premises. The main problem created by this arrangement is that its leads to a disproportionate number of negative reviews being posted, which in turn can cause a business to be incorrectly perceived as inferior. This problem is the result of the reality that customers are much more willing to take the time to post a negative review or to complain about a business than a customer is willing to take time to post a positive review.

Therefore, there is a need in the art for a system and method that improves the collection and distribution of customer feedback by offering a streamlined process for collecting customer feedback and reviews and consolidating that information in a central database where it can be accessed by a variety of third parties. These and other features and advantages of the present invention will be explained and will become obvious to one skilled in the art through the summary of the invention that follows.

### SUMMARY OF THE INVENTION

Accordingly, it is an object of the present invention to provide a system and method that collects business reviews in a central database which can then be accessed by multiple external business review providers thereby enabling an efficient proliferation of those business reviews.

According to an embodiment of the present invention, a system for collecting and streaming business reviews comprises: a business review collection module, comprising computer-executable code stored in non-volatile memory, a processor, a communication means, and a display element, wherein the business review collection module, the processor, and the communication means are operably connected and are configured to: present one or more survey questions to a user via the display element to develop a business review of a target business; receive survey input from the user, wherein the survey input is the user's response to the one or more survey questions entered through a user interface; request one or more validation inputs from the user according to one or more validation methods to authenticate the user's identity; determine whether the user is authentic by verifying the one or more validation inputs; upon a condition in which the one or more validation inputs is verified, authenticate the user's identity and accept the survey input entered by the user as a validated survey response; and upload the validated survey response to a database to be incorporated into a business review summary, wherein the business review summary is a plurality of validated survey responses regarding the target business.

According to an embodiment of the present invention, the system further comprises: a third party review provider software module; and the business review collection module, the processor, and the communication means are further configured to: generate a public key and a private key using an asymmetric cryptography method; encrypt the validated survey response using the private key to produce an encrypted survey response; provide the public key and the encrypted survey response to two or more third party review providers; and wherein the third party review provider software module is configured to: compare one or more of the public key and the encrypted survey response to the corresponding public key or encrypted survey response of one or more other third party review providers; and use the public key to decrypt the encrypted survey response.

According to an embodiment of the present invention, the system further comprises: a third party review provider software module; and the business review collection module, the processor, and the communication means are further configured to: generate a public key and a private key using an asymmetric cryptography method; compute a first review hash of the validated survey response; encrypt the review hash using the private key to produce an encrypted review hash; provide the public key, the validated survey response, and the encrypted review hash to two or more third party review providers; and wherein the third party review provider software module is configured to: compare one or more of the public key, and the encrypted review hash to the corresponding public key or encrypted review hash of one or more other third party review providers; and use the public key to decrypt the encrypted review hash to produce a decrypted review hash; compute a second review hash of the validated survey response; and compare the second review hash to the decrypted review hash.

According to an embodiment of the present invention, the one or more validation methods are selected from a group comprising: a scannable code, a validation code, email validation, telephone number validation, biometric input, and card scan validation; and wherein the business review collection module, the processor, and the communication means are further configured to: generate a validation score based on the one or more validation methods used, wherein each of the one or more validation methods is assigned a rank or score, and at least one of the one or more validation methods is assigned a rank or score that is higher than at least one of the remaining one or more validation methods.

According to an embodiment of the present invention, the biometric input is selected from a group of biometric inputs comprising fingerprints, facial recognition, voice recognition, eye scans, palms scans, and photographic matching.

According to an embodiment of the present invention, the system further comprises a camera, wherein the business review collection module, the processor, and the communication means are further configured to: provide a link to the user; obtain one or more of GPS location, IP address, user mobile device identifying number, or user phone number, or any combination thereof; create a scannable code using one or more of GPS location, IP address, user mobile device identifying number, or user phone number, or any combination thereof; provide the scannable code to the user through the link; receive the scannable code from the user through the camera.

According to an embodiment of the present invention, the system is further configured to provide the validated survey response to one or more third party review providers according to the validation method used or a threshold of the validation score.

According to an embodiment of the present invention, the system further comprises a review summary distribution module operably connected to the business review collection module, the processor, and the communication means and configured to provide the business review summary to one or more third party business review providers.

According to an embodiment of the present invention, the user interface is a graphical user interface provided on a capacitive touch screen of a tablet computer.

According to an embodiment of the present invention, the system is configured to: receive input designating a preferred alert destination; receive input designating a preferred alert notification method; detect when the user has entered a rating or score that is below a threshold for the particular item being rated or scored; prompt the user for improvement feedback regarding how a service or product may be improved in response to detecting that the user has entered a rating or score that is below the threshold; send an alert to the preferred alert destination through the preferred alert notification method; include the rating or score that is below the threshold in the validated survey response; provide the improvement feedback to the target business.

According to an embodiment of the present invention, a method for collecting and streaming business reviews comprises the steps of: presenting one or more survey questions regarding a target business to a user via a review capture device; receiving survey input from the user, wherein the survey input is the user's response to the one or more survey questions entered through the review capture device; requesting one or more validation inputs from the user to authenticate the user's identity through one or more validation methods; determining whether the user is authentic by verifying the validation input; upon a condition in which the validation input is verified, authenticating the user's identity and accepting the survey input entered by the user as a validated survey response; and uploading the validated survey response to a database to be incorporated into a business review summary, wherein the business review summary is a plurality of validated survey responses regarding the target business.

According to an embodiment of the present invention, the method further comprises the steps of: generating a public key and a private key using an asymmetric cryptography method; encrypting the validated survey response using the private key to produce an encrypted survey response; providing the public key and the encrypted survey response to two or more third party review providers; comparing one or more of the public key and the encrypted survey response to the corresponding public key or encrypted survey response of one or more other third party review providers; and decrypting the encrypted survey response using the public key.

According to an embodiment of the present invention, the method further comprises the steps of: generating a public key and a private key using an asymmetric cryptography method; computing a first review hash of the validated survey response; encrypting the review hash using the private key to produce an encrypted review hash; providing the public key, the validated survey response, and the encrypted review hash to two or more third party review providers; comparing one or more of the public key, and the encrypted review hash to the corresponding public key or encrypted review hash of one or more other third party review providers; decrypting the encrypted review hash using the public key to produce a decrypted review hash; computing a second review hash of the validated survey response; and comparing the second review hash to the decrypted review hash.

According to an embodiment of the present invention, the one or more validation methods are selected from a group comprising: a scannable code, a validation code, email validation, telephone number validation, biometric input, and card scan validation, and the method further comprises the steps of: assigning a rank or score to each of the one or more validation methods, wherein at least one of the one or more validation methods is assigned a rank or score that is higher than at least one of the remaining one or more validation methods; generating a validation score based on the one or more validation methods used.

According to an embodiment of the present invention, the biometric input is selected from a group of biometric inputs comprising fingerprints, facial recognition, voice recognition, eye scans, palms scans, and photographic matching.

According to an embodiment of the present invention, the method further comprises the steps of: providing a link to the user; obtaining one or more of GPS location, IP address, user mobile device identifying number, or user phone number, or any combination thereof; creating a scannable code using one or more of GPS location, IP address, user mobile device identifying number, or user phone number, or any combination thereof; providing a scannable code to the user through the link; receiving the scannable code from the user through the review capture device.

According to an embodiment of the present invention, the method further comprises the step of providing the validated survey response to one or more third party review providers according to the validation method used or a threshold of the validation score.

According to an embodiment of the present invention, the method further comprises the step of providing the business review summary to one or more third party business review providers.

According to an embodiment of the present invention, the method is provided to the user through a graphical user interface on a tablet computer.

According to an embodiment of the present invention, the method further comprises the steps of: receiving input designating a preferred alert destination; receiving input designating a preferred alert notification method; detecting when the user has entered a rating or score that is below a threshold rating or score for the particular item being rated or scored; prompting the user for improvement feedback regarding how a service or product may be improved in response to detecting that the user has entered a rating or score that is below the threshold; sending an alert to the preferred alert destination through the preferred alert notification method; including the rating or score that is below the threshold in the validated survey response; and providing the improvement feedback to the target business.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with embodiments of the present invention;

FIG. 2 illustrates a schematic overview of a network, in accordance with embodiments of the present invention;

FIG. 3 illustrates a network schematic of a system, in accordance with embodiments of the present invention;

FIG. 4A illustrates a schematic of a system for collecting and streaming business reviews, in accordance with embodiments of the present invention;

FIG. 4B illustrates a schematic of a system for collecting and streaming business reviews, in accordance with embodiments of the present invention;

FIG. 5 is a process flow diagram of an exemplary method in accordance with embodiments of the present invention;

FIG. 6 is an exemplary illustration a device for capturing business reviews in accordance with an embodiments of the present invention; and

FIGS. 7A-G are an exemplary illustration of a graphical user interface in accordance with embodiments of the present invention.

FIG. 8 is a flowchart showing a process for validating a review by providing a scannable code to the user through the user's mobile device according to an embodiment of the present invention;

FIG. 9 is a diagram illustrating several methods for computing a validation score when one or more validation methods are used to validate a review according to an embodiment of the present invention;

FIG. 10 is a flowchart showing a process for encrypting a review according to an embodiment of the present invention; and

FIG. 11 is a flowchart showing a process for verifying that a review has not been modified, according to an embodiment of the present invention.

### DETAILED SPECIFICATION

The present invention generally relates to the collection and distribution of business reviews. Specifically, this invention relates to a system and method for collecting business reviews in a manner that improves the granularity of information that can be collected, allows for the needs of various different third-party review providers to be met, and prevents tampering and falsification of business reviews. Reviews with various levels of verification or validation are kept in a central database that can be accessed by multiple external business review providers. Review providers can choose which level of validation they find acceptable and use only reviews from the database that meet their requirements.

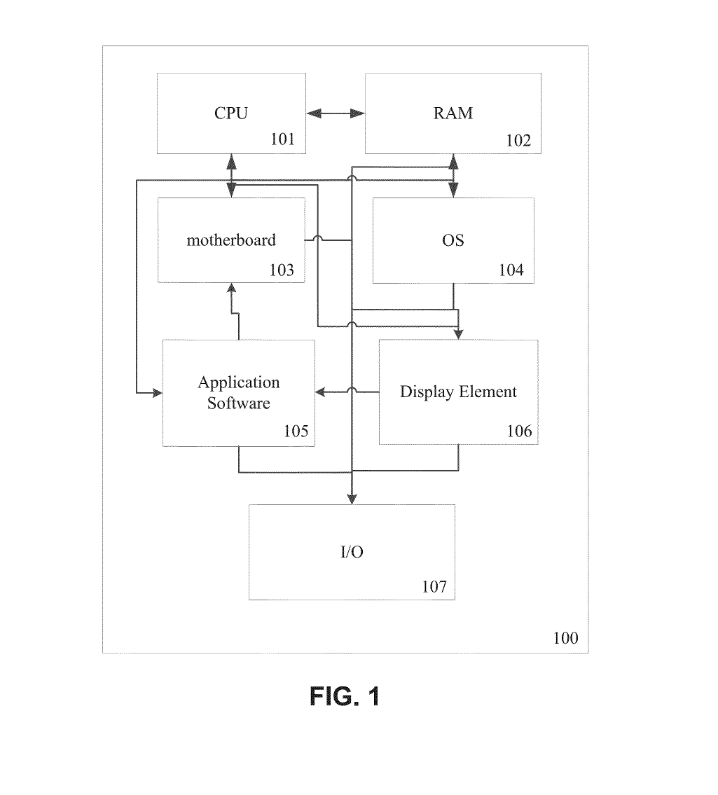

According to an embodiment of the present invention, the system and method is accomplished through the use of one or more computing devices. As shown in FIG. 1, one of ordinary skill in the art would appreciate that a computing device 100 appropriate for use with embodiments of the present application may generally comprise one or more of a Central Processing Unit (CPU) 101, Random Access Memory (RAM) 102, a storage medium (e.g., hard disk drive, solid state drive, flash memory, cloud storage) 103, an operating system (OS) 104, one or more application software modules 105, a display element 106 and one or more input/output devices/means 107. Examples of computing devices usable with embodiments of the present invention include, but are not limited to, personal computers, smart phones, laptops, mobile computing devices and tablet PCs and servers. One of ordinary skill in the art would understand that any number of computing devices could be used, and embodiments of the present invention are contemplated for use with any computing device.

In a preferred embodiment of the present invention, the computing devices utilized will incorporate one or more input means and output means for use and interaction with the system. Input means may include, but are not limited to, touchscreen interfaces, keyboard interfaces, accelerometers, gyroscope, motion sensors, buttons, cameras, microphones and 3D imaging devices, or any combination thereof. Output means may include, but are not limited to, video displays elements, audio output devices (e.g., speakers, headphones), haptic output means (e.g., force feedback devices) or any combination thereof. One of ordinary skill in the art would appreciate that there are numerous input means and output means that could be utilized with embodiments of the present invention, and embodiments of the present invention are contemplated for use with any such input means and output means.

In an exemplary embodiment according to the present invention, data may be provided to the system, stored by the system and provided by the system to users of the system across local area networks (LANs) (e.g., office networks, home networks) or wide area networks (WANs) (e.g., the Internet, cellular data networks). In accordance with the previous embodiment, the system may receive data from one or more servers or other computing devices communicatively connected across one or more LANs and/or WANs. One of ordinary skill in the art would appreciate that there are numerous manners in which the system could be connected and configured to receive and transmit (where applicable) data and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

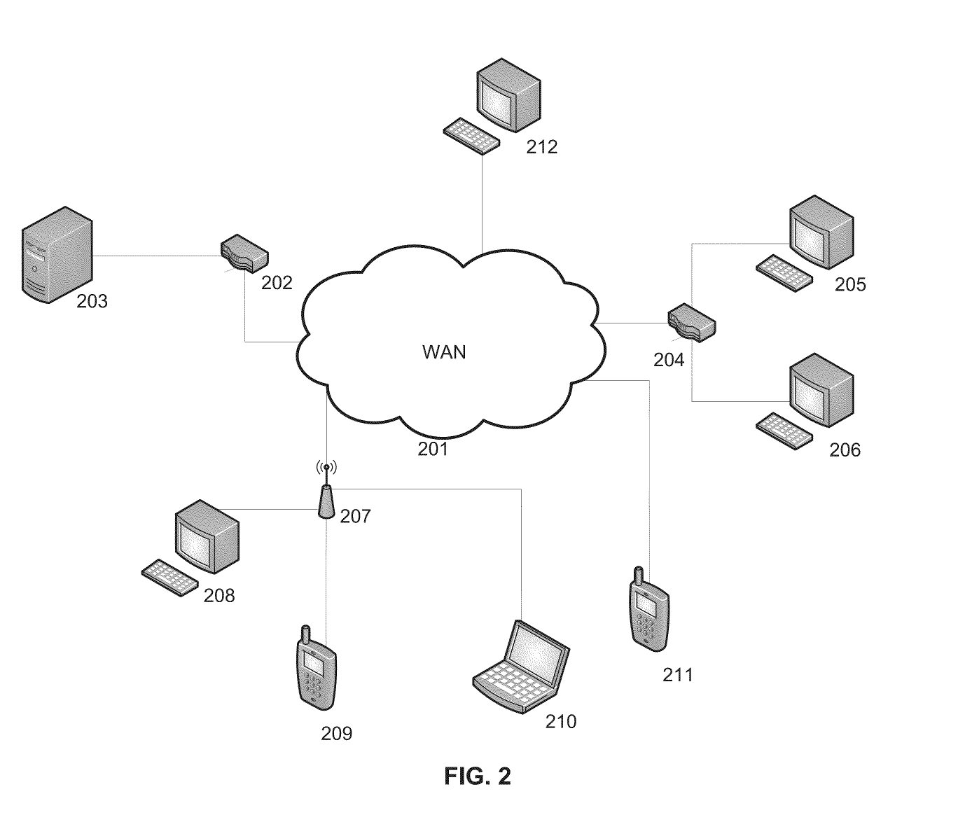

Referring to FIG. 2, a schematic overview of a system in accordance with an embodiment of the present invention is shown. Connection to such networks may be required or desirable for a mobile computing device 211 to receive data from any number of sources required for generation of the user interface in accordance with embodiments of the present invention. According to an exemplary embodiment, as shown in FIG. 2, exchange of information through the Network 201 may occur through one or more high speed connections. In some cases, high speed connections may be over-the-air (OTA), passed through networked systems, directly connected to one or more networks 201 or directed through one or more routers 202. Router(s) 202 are completely optional and other embodiments in accordance with the present invention may or may not utilize one or more routers 202. One of ordinary skill in the art would appreciate that there are numerous ways a server 203 may connect to a network 201 for the exchange of information with the mobile computing device 211 or with other computing devices for use with embodiments of the system, and embodiments of the present invention are contemplated for use with any method for connecting to networks for the purpose of exchanging information. Further, while this application refers to high speed connections, embodiments of the present invention may be utilized with connections of any speed.

Components of the system (e.g., mobile computing device 211) may connect to data server 203 via the network 201 or other networks in numerous ways. For instance, a component may connect to the system: i) through a computing device 212 directly connected to the network 201, ii) through a computing device 205, 206 connected to the WAN 201 through a routing device 204, iii) through a computing device 208, 209, 210 connected to a wireless access point 207 or iv) through a computing device 211 connected via a wireless connection (e.g., CDMA, GMS, 3G, 4G) to the network 201. One of ordinary skill in the art would appreciate that there are numerous ways that a mobile computing device 211 may connect to the server 203 via a network 201, and embodiments of the present invention are contemplated for use with any method for connecting to the server 203 via a network 201. Furthermore, the server 203 could comprise a personal computing device, such as a smartphone, acting as a host for other computing devices to connect to.

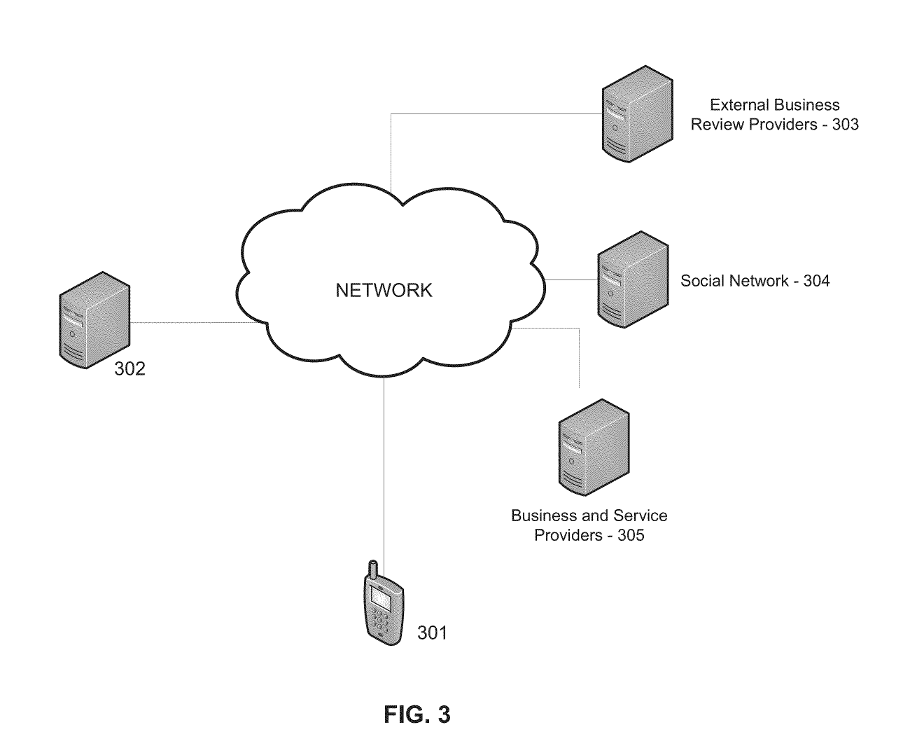

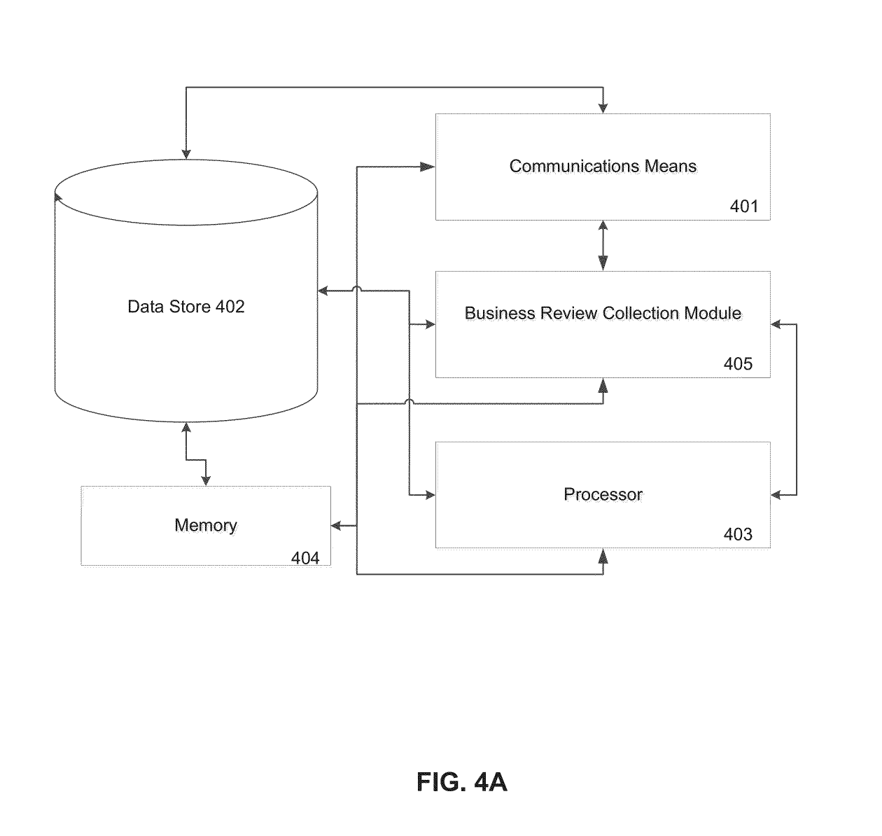

Turning now to FIG. 3, a continued schematic overview of a system in accordance with an embodiment of the present invention is shown. In FIG. 3, the system is shown as it may interact with users and other third party networks or APIs. For instance, a user of a mobile device 301 may be able to connect to the application server 302. The application server 302 may be able to enhance or otherwise provide additional services to the user by requesting and receiving information from one or more of an external business review provider API/website or other third party system 303, a social network 304, one or more business and service providers 305 or any combination thereof. Additionally, application server 302 may be able to enhance or otherwise provide additional services to an external business review provider API/website or other third party system 303, a social network 304, or one or more business and service providers 305 by providing information to those entities that is stored on a database that is connected to the application server 302. One of ordinary skill in the art would appreciate how accessing one or more third-party systems could augment the ability of the system described herein, and embodiments of the present invention are contemplated for use with any third-party system.

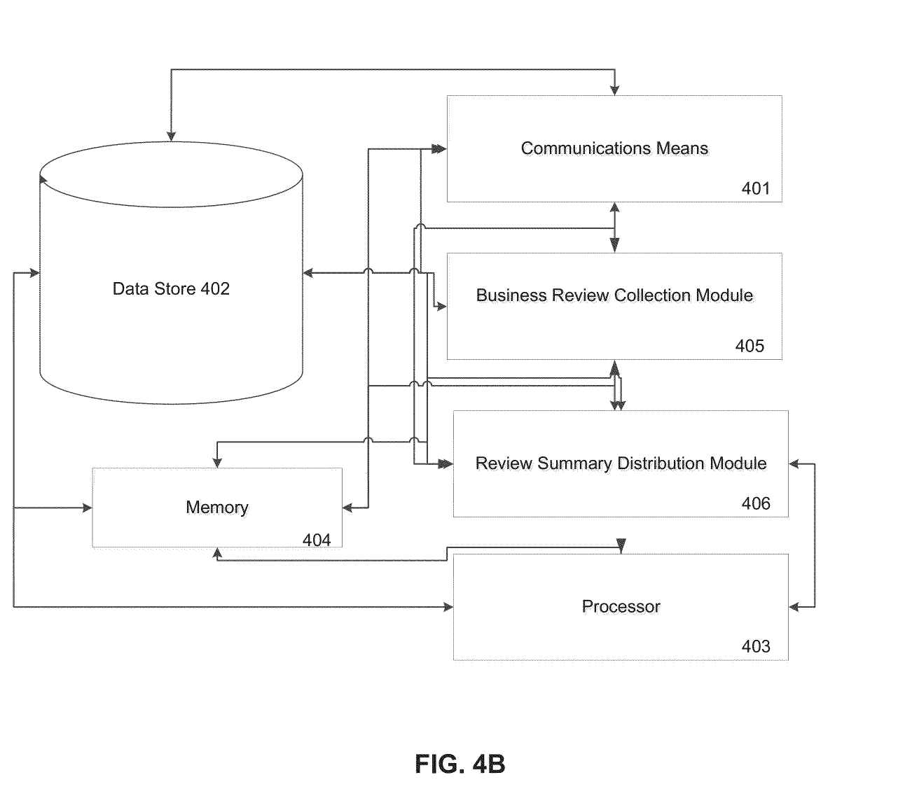

Turning to FIG. 4A, according to an embodiment of the present invention, a system for collecting and streaming business reviews comprises one or more communication means 401, one or more data stores 402, a processor 403, memory 404, and a business review collection module 405. In FIG. 4B, according to an embodiment of the present invention, a system for collecting and streaming business reviews comprises one or more communication means 401, one or more data stores 402, a processor 403, memory 404, a business review collection module 405, and a review summary distribution module 406. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communication means of the system may be, for instance, any means for communicating data, voice or video communications over one or more networks or to one or more peripheral devices attached to the system. Appropriate communication means may include, but are not limited to, wireless connections, wired connections, cellular connections, data port connections, Bluetooth connections, or any combination thereof. One of ordinary skill in the art would appreciate that there are numerous communication means that may be utilized with embodiments of the present invention, and embodiments of the present invention are contemplated for use with any communication means.

According to an embodiment of the present invention, the display element of the system may be, for instance, any type of display that is capable of displaying information to a user. In some embodiments, the display element may also be used as a user interface through which a user both receives information and enters information about a review. In a preferred embodiment, the system is configured to display a review survey and collect feedback through a user interface presented on a display element, such as a screen of a smartphone or tablet PC. Display elements may include, but are not limited to, e-ink screens, heads-up displays (e.g., presented on wearable display elements such as glasses), wearable displays (e.g., watches), smartphone displays, tablet PC displays, or any combination thereof. One of ordinary skill in the art would appreciate that there are numerous display elements that might be utilized with embodiments of the present invention, and embodiments of the present invention are contemplated for use with any display element.

According to an embodiment of the present invention, one or more systems and methods are described herein for the collection of business reviews in a central database. In a preferred embodiment, the system may be used to collect reviews and feedback at the place where the business or service is consumed by a customer. This allows a customer to submit a “live review” when the experience is fresh in the customer's mind. In an alternate embodiment, the reviews and feedback may be collected at a place that is remote from the place where the business or service is consumed. In the preferred embodiment, the reviews and feedback are collected and automatically streamed to an application server that acts as master database that stores all of the business reviews for a plurality of different business and service providers. In the preferred embodiment, any type of feedback about a business or service could be collected from a user including, but not limited to, reviews, opinions, ratings, grades, scores, rankings, and other types of feedback. In the preferred embodiment, feedback could be collected from anyone that might use a business or service including, but not limited to, retail store customers (including collecting feedback at the point of sale (e.g. at the checkout a department store)), restaurant patrons, clients of professional service providers (including, but not limited to doctors and lawyers), and users of a particular product or service. One of ordinary skill in the art would appreciate that there are numerous ways to review a business or service, and embodiments of the present invention are contemplated for use with any type of business or service review.

According to an embodiment of the present invention, the systems and methods described herein collect business reviews in a master database so that those business reviews may be accessed by or distributed to external business review providers. In the preferred embodiment, the master database may be made available to any number of external business review providers and other third parties, including, but not limited to, survey, review, or testimonial websites. In the preferred embodiment, business reviews contained in the master database may be made available through a direct feed that automatically transmits those business reviews to external business review providers that have elected to receive those business reviews. In an alternate preferred embodiment, external business review providers can also connect to the master database intermittently (e.g. automatically on a set schedule or sporadically) to capture any new or updated business reviews (i.e. capture reviews in batch form). Similarly, an external business review provider can be configured to automatically synchronize its database with the master database containing the business reviews or connect to the database to synchronize whenever a network connection becomes available. Once the business reviews have been provided to the external review provider, those business reviews can then be reposted and shared with the audience of an external review provider. One of ordinary skill in the art would appreciate that there are numerous methods by which a master database could provide business reviews to an external business review provider, and embodiments of the present invention are contemplated for use with any such method.

According to an embodiment of the present invention, the systems and methods described herein may be implemented through the use of a business review collection module. In a preferred embodiment, the business review collection module is configured to collect multiple reviews about a business and store those business reviews on a master or central database. Those business reviews may then be made accessible to external business review providers and other third parties. Additionally, those business reviews may be used to create an overall business review summary about a business. In the preferred embodiment, the business review collection module facilitates the collection of business reviews by presenting survey questions to a user, receiving survey input from the user, validating the authenticity of the user, and uploading the survey input to a master database. In alternate embodiments, the business review collection module may be configured to facilitate more or fewer functions. One of ordinary skill in the art would appreciate that a business review collection module could be configured to accomplish a variety of tasks, and embodiments of the present invention are contemplated for use with any such task.

According to an embodiment of the present invention, the systems and methods described herein may be implemented through the use of a review summary distribution module. In a preferred embodiment, the review summary distribution module is configured to regulate access to and control the distribution of the business reviews and business review summaries that are stored on the master database. In the preferred embodiment, the review summary distribution module provides external business review providers and other third parties with access to the master database. In the preferred embodiment, access may be provided through a number of methods including, but not limited to, a direct feed or live streaming of updates to those external business review providers, periodic synchronization (whether scheduled or unscheduled) between the master database and the external business review providers (i.e. automatic or manual batch collection of batches of reviews), and on demand access where the external business review providers access the master database as needed. One of ordinary skill in the art would appreciate that there are numerous possible configurations and functions for a review summary distribution module, and embodiments of the present invention are contemplated for use with any such configuration or function.

According to an embodiment of the present invention, the system and methods described herein may collect business reviews at the place where the business or service is consumed. In a preferred embodiment, the business review may be collected anywhere a business or service is consumed. For example, the reviews of a doctor may be collected in the doctor's office or in a hospital when the doctor is visiting patients. Other examples include, but are not limited to, collecting reviews and feedback at the point of sale in a retail store or entering reviews after a service is received (e.g. at a spa or salon). In the preferred embodiment, a tablet computer or other capture device (including but not limited to, smartphones, laptop computers, desktop computers, and touch screen kiosks) is used to collect the business reviews. The tablet computer or other capture device may be comprised both of a display element and a user interface. In the preferred embodiment, the display element is used to present a survey or review form to a user, while the user interface is used to collect input from the user. The user input may be collected though the touch screen of a tablet computer or through any other common input devices, such as keyboard or computer mouse. In the preferred embodiment, a tablet computer with a touch screen is used to collect the business reviews, as the tablet screen of the tablet computer can serve as both the display element and the user interface. By using a tablet computer or other portable computing device as the capture device, a business or service provider is able to take that device with them to collect reviews even when that business or service provider is not at their main location (i.e. providing service remotely, traveling for business, sales trips, etc.). One of ordinary skill in the art would appreciate that any number of devices could be used to collect business reviews, and embodiments of the present invention are contemplated for use with any such device.

According to an embodiment of the present invention, the systems and methods described herein may be configured to present one or more survey questions to a user in order to develop a review about a business or service. In the preferred embodiment, the survey questions may be any variety of questions, prompts, and other open or fillable fields that are directed at collecting the customer's feedback and impressions of a business or service. Possible survey question types include, but are not limited to, yes/no questions, multiple choice questions, ranking scales, and open testimonial fields. In some embodiments, the one or more survey questions may be a standard set of survey questions for each user. In some embodiments, the one or more survey questions may be personalized to each user based a particular response that a user provides or background information about the user (e.g. demographic information or information about what business or service that user consumed). In the preferred embodiment, the one or more survey questions are presented via the display element. One of ordinary skill in the art would appreciate that there are numerous ways to present survey questions, and embodiments of the present invention are contemplated for use with any such presentation method.

According to an embodiment of the present invention, the systems and methods described herein may be configured to receive survey input from a user. In a preferred embodiment, the survey input is a user's response to the one or more survey questions that are ultimately used to create a business review about the business or service the user consumed. In the preferred embodiment, a user enters the survey input through a user interface that is typically provided by the touch screen of a display element. In the preferred embodiment, the survey input could be entered via ranking sliders, multiple choice questions, yes/no questions, and open fields that are freely fillable. In the preferred embodiment, each of these entry methods are interactive, as the user is able to respond to the various survey questions by interacting with the touch screen of the display element and controlling any inputs that presented. In alternate embodiments, the survey input may be entered through other input means, such as computer keyboard and mouse. One of ordinary skill in the art would appreciate that there are numerous methods by which a user could enter survey input, and embodiments of the present invention are contemplated for use with any such survey input entry method.

According to an embodiment of the present invention, the systems and methods described herein may be configured to validate a user's identity and authenticate the user's input. In a preferred embodiment, the user identity is validated to ensure that the user is real. Additionally, validation of the user's identity may also provide a means to verify that the user actually used the business or service that the user is reviewing. The user's identity may be validated when the system requests the user to submit a validation input. In the preferred embodiment, the validation input may be a validation code (or confirmation key) that is sent to the user's mobile phone via text message (i.e. short messaging service (“SMS”)). Alternate validation inputs include, but are not limited to a validation code sent to the user's email address, biometrics, email address validation, phone number validation, or card swipe (or scan) validation. Examples of possible biometric validation methods include, but are not limited to, fingerprints, facial recognition, voice recognition, eye (retina) scans, palm scans, or photographic matching of other body parts (e.g. ears, hands, etc.). Examples of card swipe validations (i.e. swiping or scanning a card) include, but are not limited to, identification cards (e.g. driver's license), credit cards, and membership cards. To facilitate the validation of the user's identity, the capture device may include a camera (or other optical scanner) to take photographs or collect other visual input. Similarly, the capture device may include a card scanner or a means to connect such a device. When the user's identity is authenticated by verifying the validation input, the user's survey input is accepted as a validated survey response and sent to the master database. One of ordinary skill in the art would appreciate there are numerous methods that could be employed to validate the identity of a user and authenticate the user's input, and embodiments of the present invention are contemplated for use with any such validation method.

According to an embodiment of the present invention, the systems and methods described herein may be configured to encrypt a validated survey response. In a preferred embodiment, the business review collection module may encrypt the validated survey response on the capture device before it is sent to the master database. In an alternate preferred embodiment, the business review collection module may encrypt the validated survey response once it is received at the master database. In the preferred embodiment, the business review collection module adds an encryption or digital signature to the validated survey response so that it cannot be changed once it has been submitted by the user. In some embodiments, the user may be provided an authentication credential that allows the user to edit or update their review after it has been submitted. In a preferred embodiment, the encryption or digital signature may also be used by external business review providers to verify the authenticity of a review. For example, each time an external business review provider pulls business reviews from the master database, the digital signature can be used to cross check each review for its authenticity. One of ordinary skill in the art would appreciate there are many methods for encrypting the survey response, and embodiments of the present invention are contemplated for use with any such method.

According to an embodiment of the present invention, a user's validated survey response comprises the user's survey input. In a preferred embodiment, the user's survey input is authorized as a validated survey response upon verification of the validation input. In the preferred embodiment, the validated survey response is a completed business review that contains a user's feedback and opinions about the business, product, or service that was used or consumed by the user. In the preferred embodiment, the validated survey response (or business review) is then uploaded to the master database (or application server) where it is incorporated into the business review summary of a particular business.

According to an embodiment of the present invention, the systems and methods described herein may be configured to compile an overall business review summary about a particular business. In a preferred embodiment, the business review summary is the total collection of all the various business reviews (or validated survey responses) about a particular business, service, or product. In the preferred embodiment, each business review summary is made available to external business review providers and other third party providers of consumer review information. One of ordinary skill in the art would appreciate that there are many methods by which a business review summary could be compiled, and embodiments of the present invention are contemplated for use with any such method of collection.

According to an embodiment of the present invention, the systems and methods described herein may be configured to provide business review summaries to external business review providers and other third party providers of consumer review information. In a preferred embodiment, an external business review provider may be any website or similar source of consumer reviews, testimonials, and other feedback. Additional examples of external business review providers include, but are not limited to, social networking websites and the websites of business and service providers. In the preferred embodiment, the master database (or application server) will provide a centralized location where external business review providers can access business review summaries related to a plurality of different business and use that information to populate reviews on their own websites or other outlets. In the preferred embodiment, the access to and distribution of the business review summaries may be regulated by the review summary distribution module. Additionally, the external business review providers may also be configured to receive the business review summaries via an Application Programming Interface (API). In some embodiments, the review summary distribution module may incorporate an API to provide access to external business review providers. By providing access to the master database, the system and methods described herein allow for external business review providers to repost the reviews contained on the master database to be shared with a larger audience of people. Additionally, the master database provides a reliable source for business reviews, thereby allowing multiple external business review providers to benefit from the consolidation of business reviews in one location, which in turn benefits both consumers and businesses. This benefit for consumers comes from the fact that reviews should be more easily discoverable and the benefit for businesses is that their reviews are being more widely distributed. One of ordinary skill in the art would appreciate that there are many examples of external business review providers, and embodiments of the present invention are contemplated to be used with any such external business review providers.

### EXEMPLARY EMBODIMENTS

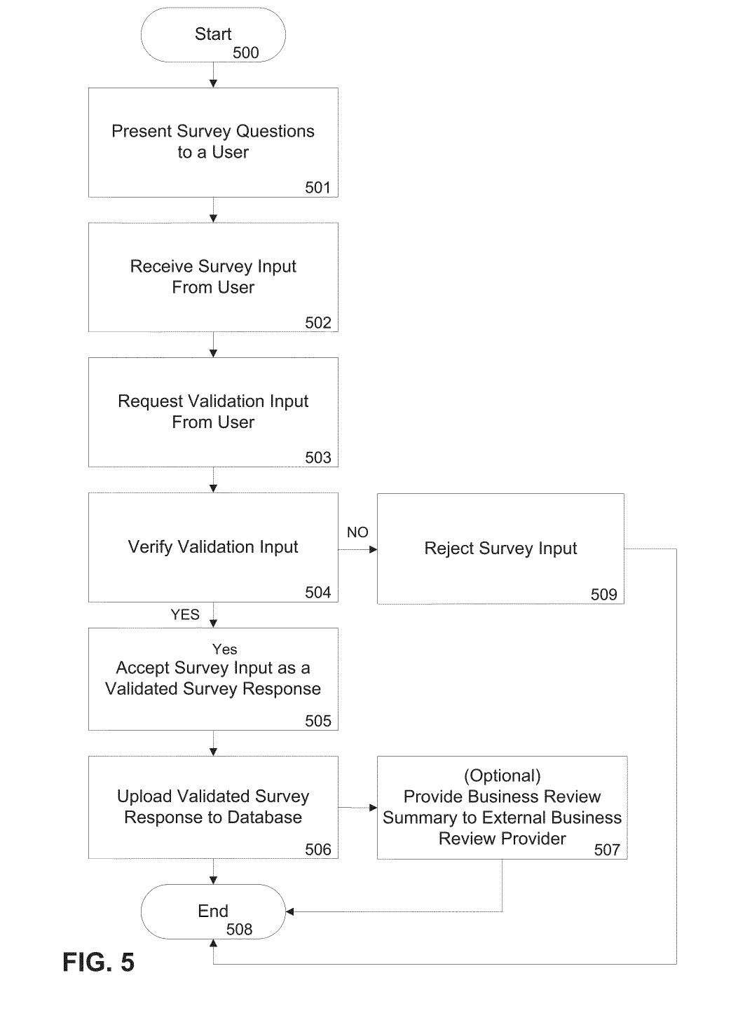

According to an embodiment of the present invention, below is an exemplary method for collecting and streaming business reviews, as shown in FIG. 5.

At step 500, the method begins with the capture device being activated and checking for any software updates. Software updates may include updates to the review template or set of questions presented to the user. Any required updates will be performed as needed. In the preferred embodiment, the capture device may be a tablet computer or any other computing device equipped with a display element and means to receive user input. At step 501, the user is presented with survey questions in order to collect a business review about the business or service consumed by the user.

At step 502, survey input is received from the user. In a preferred embodiment, the survey input is the user's response to the survey questions. In the preferred embodiment, the survey input is entered by the user through a graphical user interface displayed on the capture device.

At step 503, the system requests a validation input from the user. In a preferred embodiment, the validation input is used to verify the user's identity and authenticate the user's survey input. At step 504, the validation input is verified by the system. At step 505, upon verification of the validation input, the survey input is accepted as a validated survey response. At step 509, if the validation input is not verified or is otherwise rejected, the survey input is not accepted and the process may be ended (at step 508). When a validation input or validation code is sent to a mobile phone (or email), it could happen that the user has no reception at that moment. In the preferred embodiment, the system will store the review and at a later time when the user has reception the user can reply with validation input which will confirm the validity of that review.

At step 506, the validated survey response is uploaded to the master database (or application server). In some embodiments, the validated survey response may be encrypted before being uploaded to the master database. In a preferred embodiment the validated survey response is a business review that becomes a part of a business's overall business review summary. In a preferred embodiment, the business review summary is the collection of all of the business reviews submitted about a particular business or service.

At step 507, the business review summary is made accessible by and distributed to external business review providers that post the business reviews on their own websites. At step 508, the process terminates.

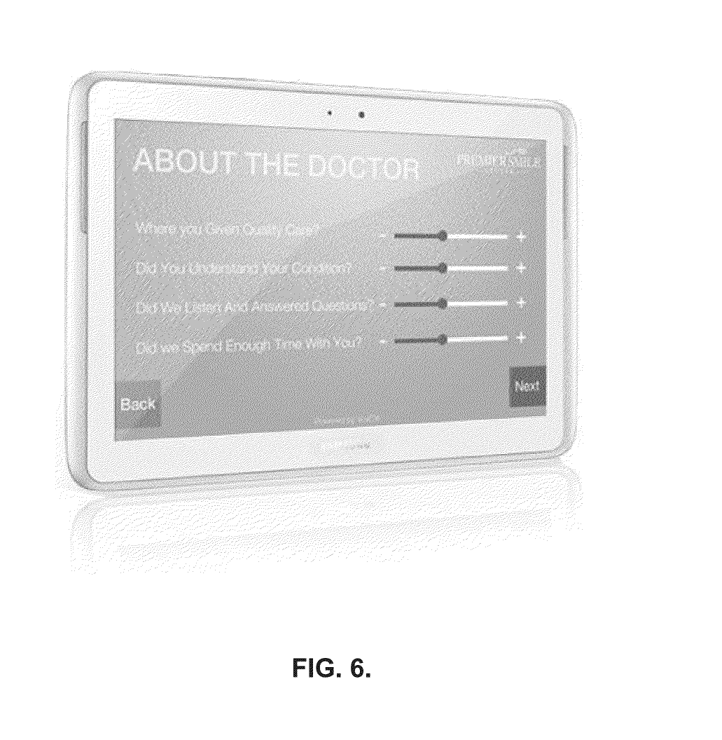

Turning now to FIG. 6, an exemplary embodiment of a capture device is shown in accordance with an embodiment of the present invention. In a preferred embodiment of the present invention, the capture device is a tablet computer with a capacitive touch screen. One of ordinary skill in the art would appreciate there are numerous devices that are suitable for use as a capture device, and embodiments of the present invention are contemplated for use with any such device.

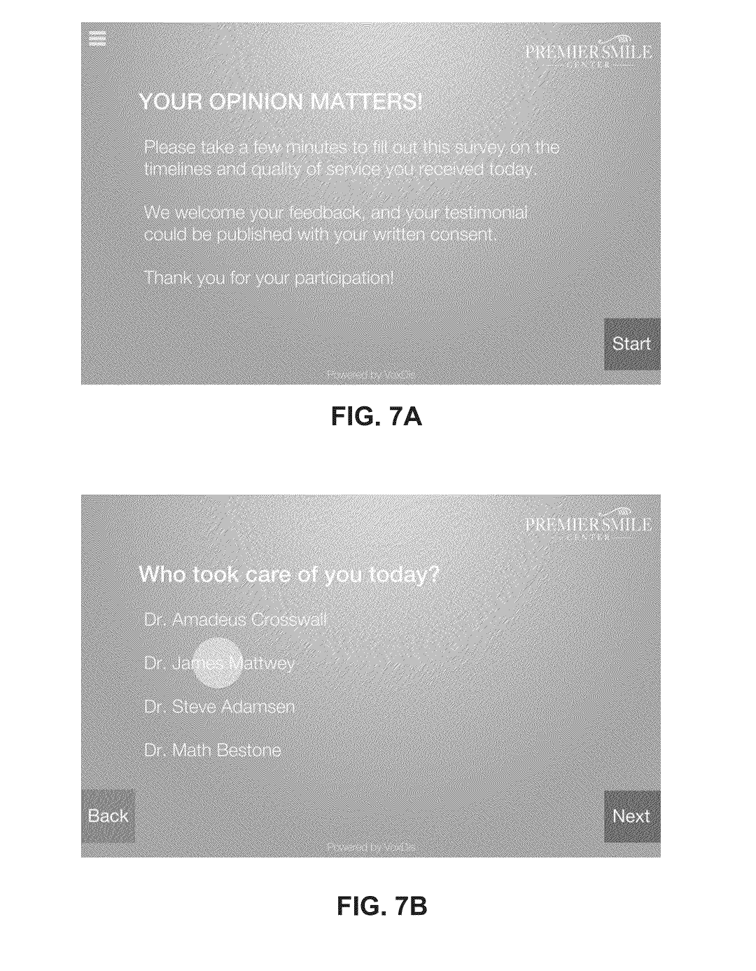

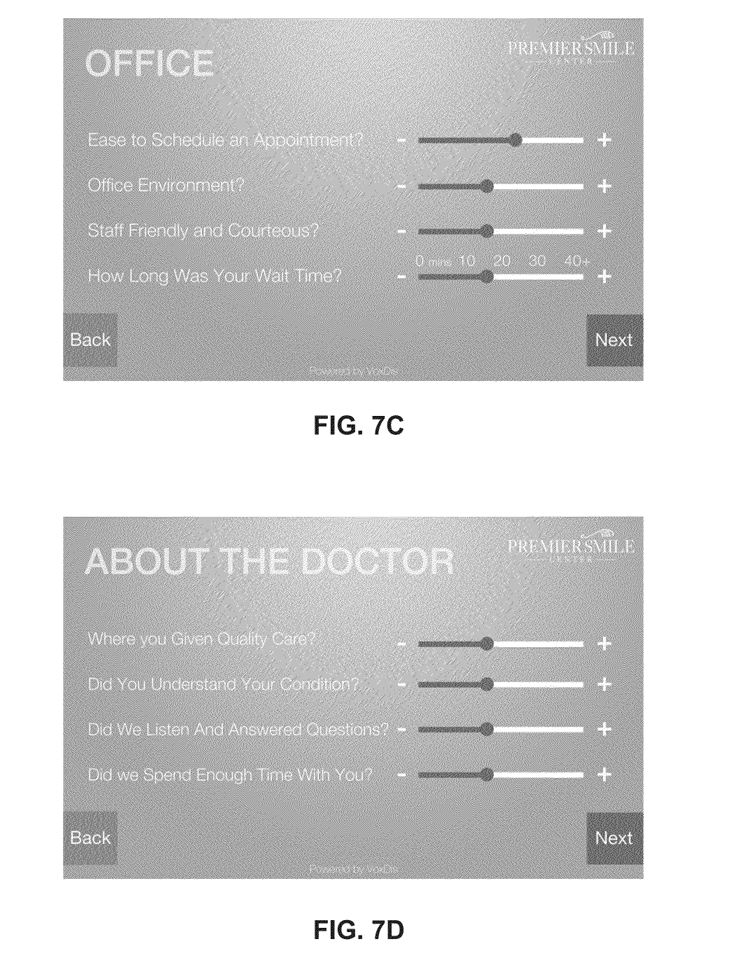

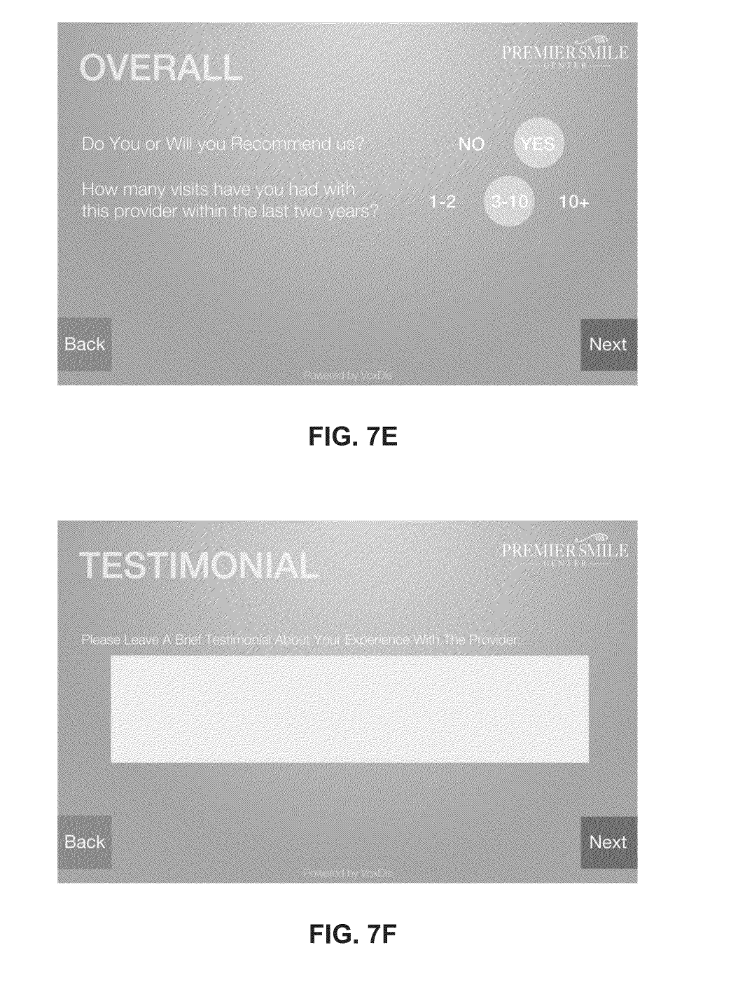

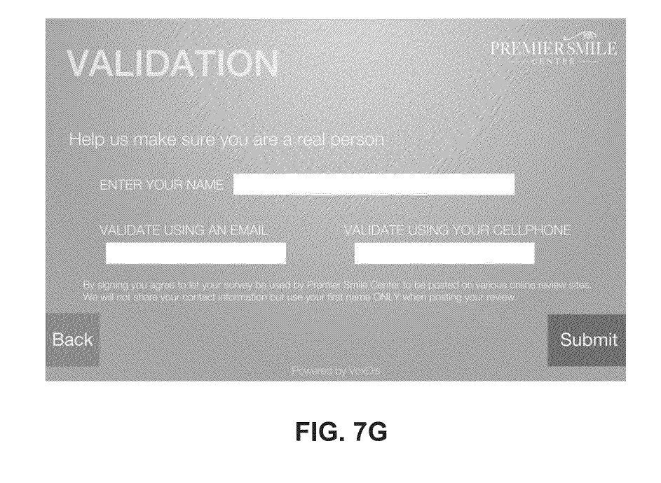

Turning now to FIGS. 7A-G, an exemplary embodiment of a graphical user interface is depicted, in accordance with an embodiment of the present invention. In the preferred embodiment, the graphical user interface provides interactive graphics and text on the capacitive touch screen of a tablet computer. FIG. 7B shows an illustrative example of a selectable multiple choice question. FIGS. 7C-D show an illustrative example of a slider selectors that may be used to rate different aspects of a business. FIG. 7E shows an illustrative example of a yes/no question and a multiple choice question. FIG. 7F shows an illustrative example of an open field for a testimonial or other user-generated entry. FIG. 7G shows an illustrative example of a validation page. One of ordinary skill in the art would appreciate any suitably configured graphical user interface could be used with embodiments of the present invention, and embodiments of the present invention are contemplated for use with any such graphical user interface.

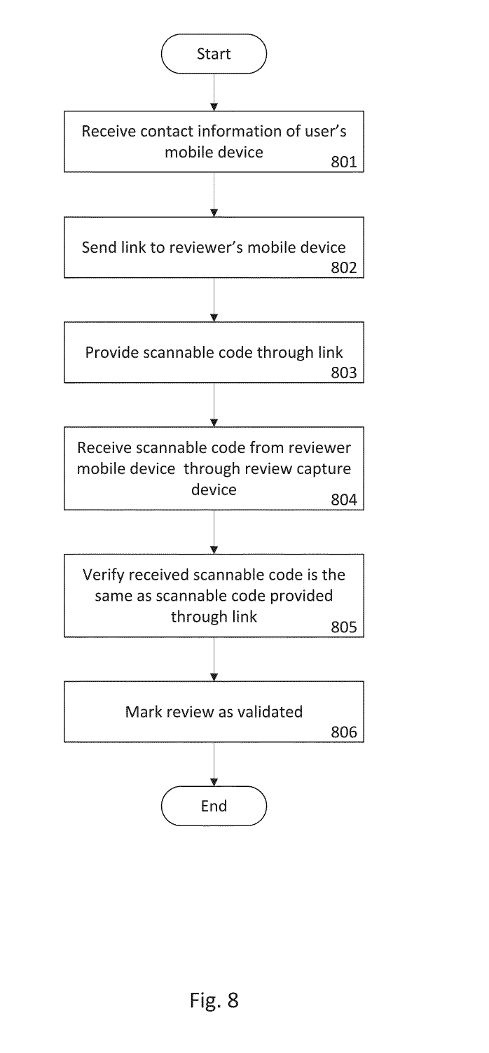

According to a preferred embodiment of the present invention, review validation is done through a series of steps shown in FIG. 8. As the user is filling out the review, the user is presented with an opportunity to validate the review at some point, preferably at the end or the review survey. In step 801, the system receives contact information for the user's mobile device. In many cases, this is a mobile phone number, but any form of contact information can be used, including email, instant messaging ID, Skype, etc. At step 802, a link is sent to the user's mobile device by text message, sms, or other communication method. The link provides access to a unique identifying scannable code which can be displayed on the screen of the user's mobile device. At step 803 this scannable code is provided to the user when the user accesses the link through the mobile device. According to one embodiment, the link has a limited lifetime, for example 2-10 minutes. The scannable code is a bar code, a QR code, animated code, or any other kind of image-based code that can be captured with a camera. According to one embodiment, the scannable code is created to uniquely identify the user from data including the user name, a timestamp, and the contact information of the user's mobile device, such as the mobile phone number.

At step 804, the review capture device receives the scannable code displayed on the user's mobile device through the camera of the review capture device. After receiving the scannable code, the system verifies, in step 805, that the scannable code received through the review capture device's camera is the same scannable code that was provided through the link sent to the user's mobile device. At step 806, after the scannable code has been verified, the review provided by the user is marked as validated. In one embodiment, the review is marked as validated and the type of validation used is also recorded.

Validation can also be performed through voice recognition. The user is presented with a sentence or phrase to read through the review capture device. As the user reads the sentence or phrase, it is recorded by a microphone on the review capture device. The system then performs a voice recognition step on the recording to produce a voice signature that identifies the user. One of ordinary skill in the art would recognize that any voice recognition algorithm could be used without departing from the spirit and scope of the present invention.

One of the purposes of validation is to verify that the user is actually present at the location with the review capture device. For this purpose, biometric validation methods are effective because they place an actual person in direct proximity to the review capture device located at the place of business. A scannable code is also good, but perhaps not quite as reliable as biometric methods for placing a particular person in close proximity to the review capture device. According to an embodiment of the present invention, in order to locate the user at the place of business, the system collects GPS, IP address of the user's mobile device, and a timestamp at the time of validation. If the user uses their mobile device to click a link, the IP address can be collected. GPS location can be collected from an app that may be installed on the device and compared to the GPS location of the review capture device, or otherwise requested through a web interface. A scannable code also places the user's mobile device in proximity to the review capture device. Any of these methods could be used individually or in combination to determine that the user was actually at the business location. Validation can also be postponed to a later time if the user does not have a mobile device or has no connectivity on their mobile device.

According to an embodiment of the present invention, reviews are graded or ranked based on the validation method used. As mentioned above, validation may be accomplished through a validation code, scannable code, phone number, email address, facial recognition, finger print, voice recognition or other biometrics. Some validation methods are preferred over others and each validation method is assigned a rank or score according to how preferred it is relative to the others. The validation methods may then become the basis for generating a validation score for each review.

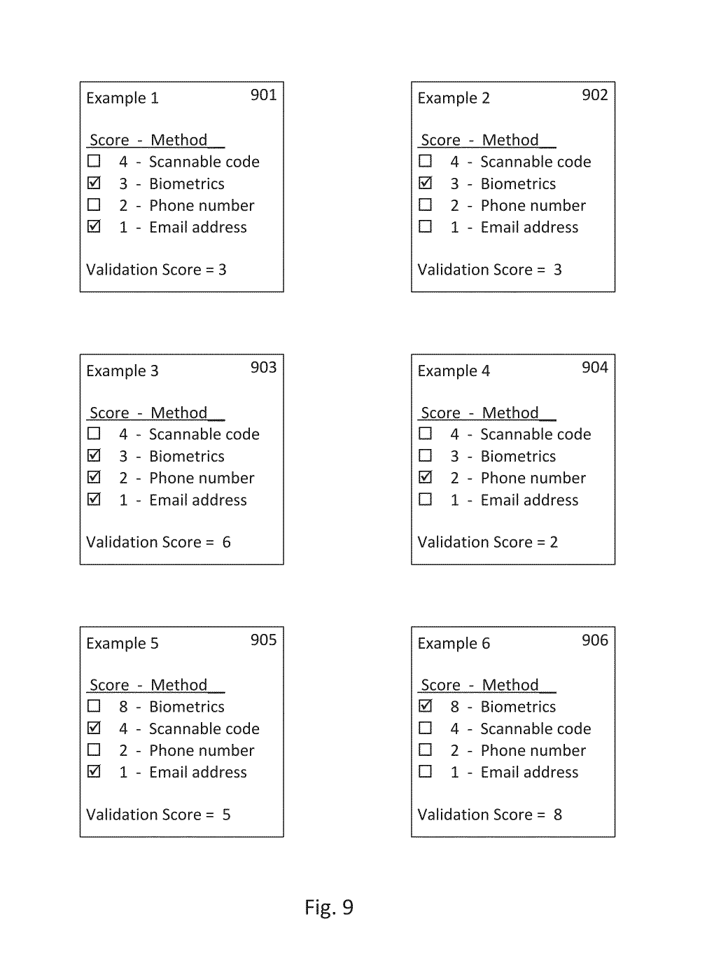

Referring to FIG. 9, there are at least two schemes in which validation methods can be ranked or graded and validation scores generated. In the first scheme, shown in example 1 901, each validation method is provided a validation score according to rank and when more than one validation method is used to validate the same review, the validation method with the highest rank provides the validation rank for the review. In example 1 901, the review is validated through biometrics with a score of 3 and email address with a score of 1. The total validation score would be 3. In example 2 902, only the biometrics method with a score of 3 is used to validate the review so the review still has a validation score of 3. In the second scheme, each validation method is given a score, and when more than one validation method is used, the scores are mathematically combined such as by addition, a weighted average, multiplication, or some other mathematical method. In example 3 903, the biometrics, phone number, and email address validation methods are all used, and the total validation score is 6, obtained by summing the individual scores of each validation method used. In example 904, only a single validation method is used and the total validation score is 2.

For the second scheme, the preferred method is to rank the validation methods and then assign a value to each validation method according to rank, such that the sum of values assigned to ranks 1 through n is less than or equal to the value assigned to rank n+1. Example 5 905 shows an example of this preferred validation ranking method. Example 5 905 includes validation through a scannable code and email address with the total validation score totaling 5. However, even if the scannable code, phone number, and email address validation methods are used, the total score comes to 7 which is still less than 8, the score assigned to the highest ranking biometrics validation method. Example 6 906 shows the same scoring model when only the biometrics validation method is used, producing a validation score of 8. This preferred method is useful when one particular validation method is better than any of the others combined, but a combination of validation methods is better than just a single validation method alone.

The examples shown in FIG. 9 are for illustration purposes only, and are not intended to designate which validation methods should be ranked higher or lower, or to designate whether a higher score or rank is supposed to indicate that a validation method is more or less preferred. In certain embodiments, lower validation rankings may be interpreted as preferred validation methods. Each validation method can be ranked and scored relative to the others according to the relative desirability or strength of the validation methods for a particular situation. For example, somebody may rank biometric validation methods higher than a scannable code, and some biometric methods may rank higher than other biometric methods. Whatever the ranking of the validation methods, any of the schemes and examples described in FIG. 9, or other schemes, may be used for ranking validation methods or combinations of validation methods without departing from the spirit and scope of the present invention.

According to an embodiment of the present invention, review grades or rankings provide a method of filtering reviews that meet validation criteria. Third party review providers can choose a validation score threshold and/or a scoring method, as described with respect to FIG. 9, in order to select and accept only the reviews which meet certain validation score criteria. Third party review providers may also designate particular validation methods which are required or acceptable while other validation methods are not acceptable regardless of the overall score computed by a particular validation score scheme. Therefore a third party review provider can choose which reviews are acceptable for providing to consumers based on the validation method or validation score or ranking.

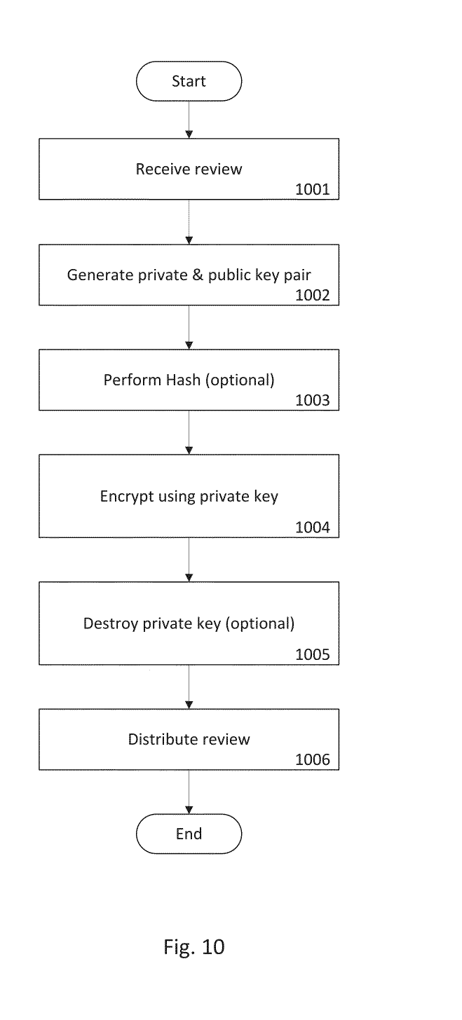

According to an embodiment of the present invention, a completed review is encrypted to prevent tampering after completion. FIG. 10 shows an exemplary process for encrypting completed reviews. At step 1001, the system receives the review. Receiving the review may happen at the review capture device or at the application server. At step 1002, the review capture device or application server generates a public/private key pair using public key cryptography or another asymmetric cryptography method. At step 1003, a hash is performed on the unencrypted completed review. This hash step is optional. The advantage of performing a hash is that, when verifying that the review has not been altered, multiple comparisons of the same review can be done faster by comparing the hash instead of the whole review. At step 1004, the review or a hash of the review is encrypted using the private key of the asymmetric key pair. If the public key is used for encryption, the private key would be required for decryption or verification. The public key and private key have a mathematical relationship to each other such that the public key can be obtained from the private key, but determining the private key from the public key is computationally infeasible. Using the private key for encryption helps prevent reverse engineering of the public key for the purpose of re-encrypting a falsified or altered review. Therefore, the private key is preferred for encryption of reviews because it is more difficult to falsify a review encrypted with the private key.

Although the same private key can be used to encrypt more than one, or even all reviews, security can be increased by using each private key to encrypt only a single review. Because each review only needs to be encrypted once (using the private key), but decrypted (using the public key) possibly multiple times, if a unique key is used for each review, it is not necessary to keep the private key once the review has been encrypted. Therefore, in step 1005, the private key may be optionally destroyed. This helps to improve security because it prevents the private key from being stolen, hacked, or otherwise unintentionally revealed. At step 1006, the review is distributed to third party review providers. If only a hash of the review is encrypted, then the unencrypted (readable) review is distributed along with the encrypted hash and the public key used for verifying that the review has not been modified. If the entire review is encrypted, then just the encrypted review and the public key can be distributed. In this case distributing the unencrypted review is optional because it can be obtained by using the public key to decrypt the encrypted review. In either case, at least the public key and the encrypted review hash or the encrypted review should be distributed, or otherwise made available.

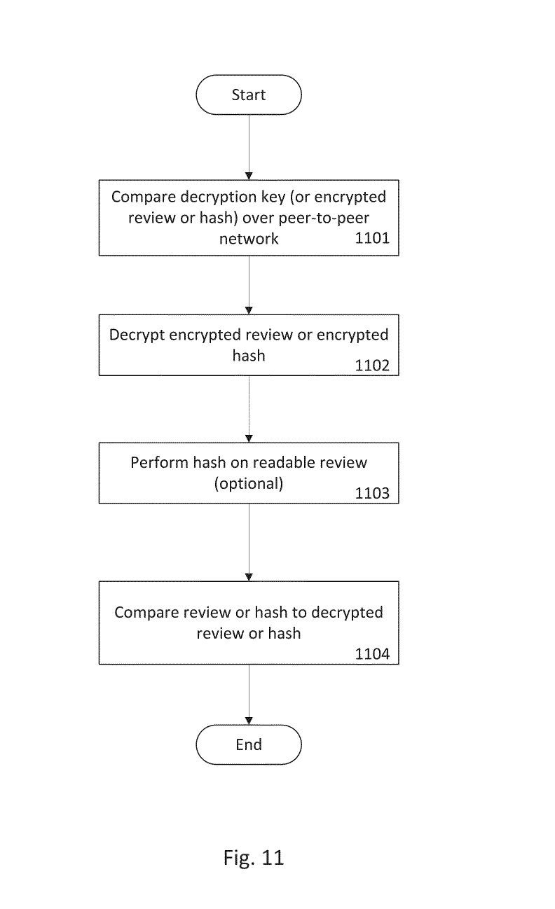

Once the review has been distributed, then the integrity of the review can be verified for third party review providers by the process shown in FIG. 11. In one embodiment this can be done through a third party review provider software module configured to interface with the application server or central database to receive the necessary file components. In step 1101, the system uses a peer-to-peer network to verify at least one of the local copies of file components: the public key, the encrypted review, and the encrypted review hash. A peer to peer network is established among several third party review providers. This peer-to-peer network distributes multiple copies of the public key, the encrypted review, and/or the encrypted review hash related to each review to several third party review providers. One or more of these multiple copies can be compared to the local copy to verify that the local copy has not been modified or tampered with. As more comparisons are made with matching results, the level of confidence in the accuracy of the local copy increases. Alternatively, a verification copy of the public key, the encrypted review, and/or the encrypted review hash can be stored on a server for comparison with the local copy. However, the preferred method is to use a peer-to-peer network because it is less susceptible to being compromised, or spoofed, and provides multiple comparison points for increased confidence in the comparison results.

In a preferred embodiment, either the public key, or the encrypted review hash, whichever is smaller, is compared over the peer-to-peer network. Choosing the smallest file component to compare reduces transmission and comparison times. In order to produce a modified review, one would have to take the unencrypted or decrypted review in readable form, modify it, produce a new private/public key pair, and replace the locally stored public key, and the encrypted review hash or the encrypted review. Even if this is accomplished, we only need to find one of these file components not matching the others on the peer-to-peer network in order to detect and correct the problem. Therefore, only one of the public key, the encrypted review, or the encrypted review hash needs to be compared, although all of them can be compared, if desired.

At step 1102 the encrypted review hash or the encrypted review, whichever is available, is decrypted to produce a decrypted review hash or decrypted review. If the encrypted hash is the available file component, then a hash is performed on the unencrypted review at step 1103 to produce an unencrypted review hash. At step 1104, if the encrypted review is the available file component, the decrypted review is compared to the unencrypted review to verify that the review remains unchanged. If the encrypted hash is the available file component, then the decrypted hash is compared to the unencrypted review hash computed in step 1103. If the public key matches the public keys on the peer-to-peer network, and the decrypted file component (review hash or review) matches the unencrypted file component, then the review is verified as being unmodified.

According to an embodiment of the present invention, a user is presented with a scale for rating the quality of services or products provided by a business. When a user rates a service or product below the average rating for that service or product, then an alert is triggered. If there is not enough data collected to determine an average score for a particular service or product, then 50% of the highest possible rating is determined to be the average. Alternatively, a business or customer that is collecting the review may set a threshold or define a computation for determining a threshold. The threshold is then used to determine when alerts are triggered. The alert may be sent by sms, mms, email or any other messaging system. In a preferred embodiment, the alert is sent to a mobile device of an employee, alerting them to the possibility of a dissatisfied customer that may need additional service. In addition, when a user rates a service or product below the average rating, a feedback text box is presented to the user along with a prompt asking how service can be improved. The contents entered into this feedback text box are provided to the business but are not included in the review that is distributed to third party review providers. Nevertheless, the rating of a product or service that the user entered which was below the average rating or below the threshold is included in the review distributed to third party review providers and is not necessarily excluded from any combined or aggregate score that is calculated for the review. The business may choose to be alerted of a below-average rating immediately or at the end of the review, and the business can set the alert method, either by email, sms, or another messaging system. Each review capture device may be independently configured with alert preferences including, but not limited to, alert destination, alert timing, alert notification method, and alert trigger threshold. One of ordinary skill in the art would recognize that any electronic messaging system could be used to produce alerts and any electronic device can be used to present the alert to the employees and other staff on site, without departing from the spirit and scope of the present invention.

According to an embodiment of the present invention, the review collection device is synced with the application server before a review collection process begins. The server stores a template containing a collection of questions pertaining to a particular industry category in which the business being reviewed belongs. The template contains a combination of all the questions that are relevant to the particular industry of the business. Therefore, although each business or third party review provider might be interested in a different set of questions, the combination of those sets is contained within a single survey template that can serve the needs of all businesses and third party review providers at once. Businesses can also inject customized questions particular to that business into the survey. These customized questions are submitted to the application server and provided to the review capture device when it is synced with the application server. When the review collection device syncs with the application server, the latest version of the template, and customized questions, are sent to the review collection device. This system also allows for centrally updating all review collection devices through the application server if there is a change in the industry or among third party review providers that requires an update to the questions contained in the template.

According to an embodiment of the present invention, the review collection device can provide staff-level feedback. The application server receives a staff list from the business and presents that staff list to the user when asking who served the user. This allows service quality to be tied to a particular member of the staff while general services that are not staff-specific are attributed to the business in general. This allows a business to make assessments of individual staff members and determine who among the staff is providing quality service and who requires additional training or improvement. A menu page is provided to allow a business to edit or update the staff list presented by the review collection device.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may comprise one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for collecting and streaming business reviews, the system comprising:
a business review collection module, comprising computer-executable code stored in non-volatile memory,
a processor,
a communication means, and
a display element,
wherein said business review collection module, said processor, and said communication means are operably connected and are configured to:
present one or more survey questions to a user via said display element to develop a business review of a target business;
receive survey input from said user, wherein said survey input is said user's response to said one or more survey questions entered through a user interface;
request one or more validation inputs from said user according to one or more validation methods to authenticate said user's identity;
determine whether said user is authentic by verifying said one or more validation inputs;
upon a condition in which said one or more validation inputs is verified, authenticate said user's identity and accept said survey input entered by said user as a validated survey response; and
upload said validated survey response to a database to be incorporated into a business review summary, wherein said business review summary is a plurality of validated survey responses regarding said target business.

2. The system of claim 1 further comprising:
a third party review provider software module;
wherein said business review collection module, said processor, and said communication means are further configured to:
generate a public key and a private key using an asymmetric cryptography method;
encrypt said validated survey response using said private key to produce an encrypted survey response;
provide said public key and said encrypted survey response to two or more third party review providers; and
wherein said third party review provider software module is configured to:
compare one or more of said public key and said encrypted survey response to the corresponding public key or encrypted survey response of one or more other third party review providers; and
use said public key to decrypt said encrypted survey response.

3. The system of claim 1 further comprising:
a third party review provider software module;
wherein said business review collection module, said processor, and said communication means are further configured to:
generate a public key and a private key using an asymmetric cryptography method;
compute a first review hash of said validated survey response;
encrypt said review hash using said private key to produce an encrypted review hash;
provide said public key, said validated survey response, and said encrypted review hash to two or more third party review providers; and
wherein said third party review provider software module is configured to:
compare one or more of said public key, and said encrypted review hash to the corresponding public key or encrypted review hash of one or more other third party review providers; and
use said public key to decrypt said encrypted review hash to produce a decrypted review hash;
compute a second review hash of said validated survey response; and
compare said second review hash to said decrypted review hash.

4. The system of claim 1 wherein said one or more validation methods are selected from a group comprising: a scannable code, a validation code, email validation, telephone number validation, biometric input, and card scan validation; and wherein said business review collection module, said processor, and said communication means are further configured to:
generate a validation score based on said one or more validation methods used,
wherein each of said one or more validation methods is assigned a rank or score, and
at least one of said one or more validation methods is assigned a rank or score that is higher than at least one of the remaining one or more validation methods.

5. The system of claim 4, wherein said biometric input is selected from a group of biometric inputs comprising fingerprints, facial recognition, voice recognition, eye scans, palms scans, and photographic matching.

6. The system of claim 4 further comprising a camera, and wherein said business review collection module, said processor, and said communication means are further configured to:
provide a link to said user;
obtain one or more of GPS location, IP address, user mobile device identifying number, or user phone number, or any combination thereof;
create a scannable code using one or more of GPS location, IP address, user mobile device identifying number, or user phone number, or any combination thereof;
provide a scannable code to said user through said link; and
receive said scannable code from said user through said camera.

7. The system of claim 4 wherein said business review collection module, said processor, and said communication means are further configured to:
provide said validated survey response to one or more third party review providers according to the validation method used or a threshold of said validation score.

8. The system of claim 1, further comprising a review summary distribution module operably connected to said business review collection module, said processor, and said communication means and configured to provide said business review summary to one or more third party business review providers.

9. The system of claim 1, wherein said user interface is a graphical user interface provided on a capacitive touch screen of a tablet computer.

10. The system of claim 1 wherein said business review collection module, said processor, and said communication means are further configured to:
receive input designating a preferred alert destination;
receive input designating a preferred alert notification method;
detect when said user has entered a rating or score that is below a threshold for the particular item being rated or scored;
prompt said user for improvement feedback regarding how a service or product may be improved in response to detecting that said user has entered a rating or score that is below the threshold;
send an alert to said preferred alert destination through said preferred alert notification method;
include said rating or score that is below the threshold in said validated survey response; and
provide said improvement feedback to said target business.

11. A method for collecting and streaming business reviews, the method comprising the steps of:
presenting one or more survey questions regarding a target business to a user via a review capture device;
receiving survey input from said user, wherein said survey input is said user's response to said one or more survey questions entered through said review capture device;
requesting one or more validation inputs from said user to authenticate said user's identity through one or more validation methods;
determining whether said user is authentic by verifying said validation input;
upon a condition in which said validation input is verified, authenticating said user's identity and accepting said survey input entered by said user as a validated survey response; and
uploading said validated survey response to a database to be incorporated into a business review summary, wherein said business review summary is a plurality of validated survey responses regarding said target business.

12. The method of claim 11, further comprising the steps of:
generating a public key and a private key using an asymmetric cryptography method;
encrypting said validated survey response using said private key to produce an encrypted survey response;
providing said public key and said encrypted survey response to two or more third party review providers;
comparing one or more of said public key and said encrypted survey response to the corresponding public key or encrypted survey response of one or more other third party review providers; and
decrypting said encrypted survey response using said public key.

13. The method of claim 11 further comprising the steps of:
generating a public key and a private key using an asymmetric cryptography method;
computing a first review hash of said validated survey response;
encrypting said review hash using said private key to produce an encrypted review hash;
providing said public key, said validated survey response, and said encrypted review hash to two or more third party review providers;
comparing one or more of said public key, and said encrypted review hash to the corresponding public key or encrypted review hash of one or more other third party review providers;
decrypting said encrypted review hash using said public key to produce a decrypted review hash;
computing a second review hash of said validated survey response; and
comparing said second review hash to said decrypted review hash.

14. The method of claim 11 wherein said one or more validation methods are selected from a group comprising: a scannable code, a validation code, email validation, telephone number validation, biometric input, and card scan validation, and said method further comprising the steps of:
assigning a rank or score to each of said one or more validation methods, wherein at least one of said one or more validation methods is assigned a rank or score that is higher than at least one of the remaining one or more validation methods; and
generating a validation score based on said one or more validation methods used.

15. The method of claim 14, wherein said biometric input is selected from a group of biometric inputs comprising fingerprints, facial recognition, voice recognition, eye scans, palms scans, and photographic matching.

16. The method of claim 14 further comprising the steps of:
providing a link to said user;
obtaining one or more of GPS location, IP address, user mobile device identifying number, or user phone number, or any combination thereof;
creating a scannable code using one or more of GPS location, IP address, user mobile device identifying number, or user phone number, or any combination thereof;
providing a scannable code to said user through said link; and
receiving said scannable code from said user through said review capture device.

17. The method of claim 14 further comprising the step of providing said validated survey response to one or more third party review providers according to the validation method used or a threshold of said validation score.

18. The method of claim 11, further comprising the step of providing said business review summary to one or more third party business review providers.

19. The method of claim 11, provided to said user through a graphical user interface on a tablet computer.

20. The method of claim 11, further comprising the steps of:
receiving input designating a preferred alert destination;
receiving input designating a preferred alert notification method;
detecting when said user has entered a rating or score that is below a threshold rating or score for the particular item being rated or scored;
prompting said user for improvement feedback regarding how a service or produce may be improved in response to detecting that said user has entered a rating or score that is below the threshold;
sending an alert to said preferred alert destination through said preferred alert notification method;
including said rating or score that is below the threshold in said validate survey response; and
providing said improvement feedback to said target business.
